(19) United States
(12) Patent Application Publication
(10) Pub. No.: US 2005/0164149 A1
(43) Pub. Date: Jul. 28, 2005

(54) Immersion learning system and method

(76) Inventors: Oleg A. Vyadro, Newton, MA (US); Michaela R. Vyadro, Brookline, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/953,799

(22) Filed: Sep. 29, 2004

Related U.S. Application Data
(60) Provisional application No. 60/538,689, filed on Jan. 26, 2004.

(51) Int. Cl. G09B 19/22

(52) U.S. Cl. 434/129

(57) ABSTRACT

The invention generally relates to learning cards, systems of instructing and methods of instructing using the learning cards. More specifically, the invention relates to learning cards having a front side and a back side. The front side includes a background, first information, and second information. The second information is related to the first information. The back side includes an adhesive for adhering to any of a variety of surfaces. The adhesive can be removed from a surface and re-adhered to the same or a different surface. The learning card is used, for example, to aid a person learning the relationship between the first information and the second information.

This application claims priority to U.S. Provisional Patent Application Ser. No. 60/538,689 filed on Jan. 26, 2004, the entire contents of which are incorporated by reference herein.

### TECHNICAL FIELD

The invention generally relates to learning cards, systems of instructing and methods of instructing using the learning cards.

### BACKGROUND INFORMATION

Many students learning information (e.g., math, geography, and vocabulary in their own language or in a foreign language) use flash cards to aid in information memorization. Typically, flash cards include a question on the front side and an answer to the question on the back side. For example, the front side of a flash card has a word in the French language and the back side of the flash card has the definition of the word in the English language. The student can easily put the flash cards down, walk away from the flash cards, and delay studying. The effectiveness of flash cards is limited when, for example, the student becomes bored of using them.

### SUMMARY OF THE INVENTION

There is a need in the art for learning tools, systems of instruction, and methods of instruction that avoid student procrastination. A new learning card and systems of instructing and methods of instructing using the learning cards have been developed.

Immersion can be an effective way to learn a foreign language or any of a variety of other information. Immersion learning generally involves immersing a person in a learning environment. Foreign language immersion programs, for example, can be successful because they surround the student in an environment where the foreign language is everywhere. The foreign language immersion student is unable to avoid the information to be learned, thereby forcing the student to learn the information.

In accordance with the invention, a student views one or more learning cards that are removably adhered to any of a variety of surfaces. The learning card or cards enable the student to learn information on the learning card(s). Aspects of the invention generally relate to creating an immersion environment by surrounding a student with one or more learning cards including information to be learned by the student. The immersion environment facilitates memorization and long-term retention of information.

In one aspect, the invention relates to a learning card having a front side and a back side. The front side includes a background, first information, and second information. The second information is related to the first information. The back side includes an adhesive for adhering to any of a variety of surfaces. The adhesive can be removed from a surface and re-adhered to the same or a different surface. The learning card is used, for example, to aid a person learning the relationship between the first information and the second information.

The information on the learning card is on a single side of the learning card. The learning card differs from flash cards at least because flash cards have information on both a front side and a back side.

In one embodiment, the first information has a first typeface and the second information has a second typeface. Suitable typeface styles include, for example, print style and cursive style typeface. An exemplary learning card has a first information with a first typeface and a second information with a second typeface, the first typeface is a print style and the second typeface is a cursive style. Alternatively, both the first typeface and second typeface are the same style, e.g., a print style. In another embodiment, the first typeface is a larger size than the second typeface, for example, the first typeface is about 400% larger in size than the second typeface.

The learning card may have a shape, for example, a shape having at least three sides or at least a portion of a curve. In one embodiment, the adhesive on the back side of the learning card is a water based adhesive. A release liner is adapted to contact the adhesive and the release liner can include, for example, a tab to ease separation of the release liner from the adhesive. In another embodiment, one or more release liners are compiled together in, for example, a book, binder or other compilation. A single release liner may be adapted to hold one or more learning cards.

In another aspect, the invention involves a system for instructing in which a plurality of the learning cards is provided. Each learning card has a front side and a back side, the front side includes a background, first information, and second information, the second information is related to the first information and the back side includes an adhesive. The adhesive is adapted to adhere to any of a variety of surfaces and to be removable and re-adhereable to the same or a different one of the surfaces. The first information of at least one of the plurality of learning cards is different than the first information of at least a different one of the plurality of learning cards.

In yet another aspect, the invention relates to a method of instructing a student. The method generally includes: providing a learning card having a front side and a back side, the front side including a background, first information, and second information, the second information is related to the first information and the back side includes an adhesive, instructing the student to removably adhere the back side of he learning card to any of a variety of surfaces, and instructing the student to view the learning card. One embodiment includes providing a plurality of learning cards and, optionally, instructing the student to view a plurality of the learning cards.

In yet another aspect, the invention involves a method of instructing. The method generally includes: providing a learning card having a front side and a back side, the front side including a background, first information, and second information, the second information is related to the first information and the back side includes an adhesive, providing instructions to removably adhere the back side of the learning card to any of a variety of surfaces, and providing instructions to view the learning card. One embodiment includes providing a plurality of learning cards and, optionally, providing instructions to view a plurality of learning cards.

In still another aspect, the invention features a method of student instruction. The method generally includes: obtaining a learning card having a front side and a back side, the front side including a background, first information, and second information, the second information is related to the first information and the back side includes an adhesive, removably adhering the back side of the learning card to any of a variety of surfaces, and viewing the learning card. One embodiment includes providing a plurality of learning cards and, optionally, viewing a plurality of the learning cards.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a plan view of an embodiment of a learning card in which adhesive on the back side of the learning card is in contact with a release liner.

FIG. 2 is a plan view of the learning card and release liner of FIG. 1, where the adhesive is shown being detached from the release liner.

FIG. 3 is a plan view of the learning card and release liner of FIG. 1, where the learning card is detached from the release liner.

FIG. 4 is a plan view of an embodiment of a page of a compilation of release liners in contact with adhesive on the back side of multiple learning cards.

FIG. 5 is a view of an embodiment of multiple learning cards of the invention adhered to a surface.

### DESCRIPTION

The invention relates to learning cards having a front side and a back side. The front side includes a background, first information, and second information. The second information is related to the first information. The back side includes an adhesive for adhering to any of a variety of surfaces. The adhesive can be removed from a surface and re-adhered to the same or a different surface. The learning card is used, for example, to aid a person learning the relationship between the first information and the second information. The learning card and systems and methods of instructing using learning card(s) may be employed to surround a student with information to be learned. Unlike flash cards that have information on a front side and a back side, the first information and second information are on a single side of the learning card, the front side. A student views one or more learning cards that are removably adhered to any of a variety of surfaces and the learning card or cards enable the student to learn information on the learning cards. The learning cards create an immersion environment and facilitate memorization and long-term retention of information.

It should be understood that the order of steps or order for performing certain actions are immaterial so long as the invention remains operable. Moreover, two or more steps or actions may be conducted simultaneously.

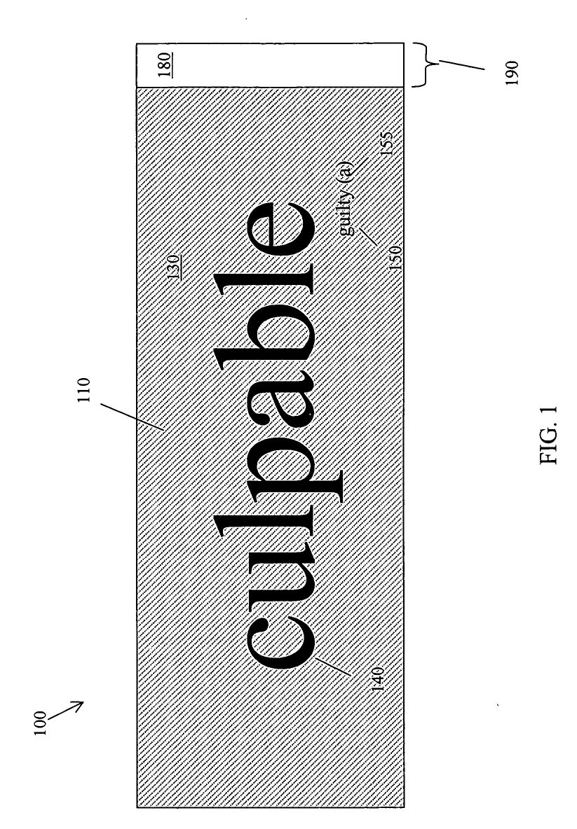

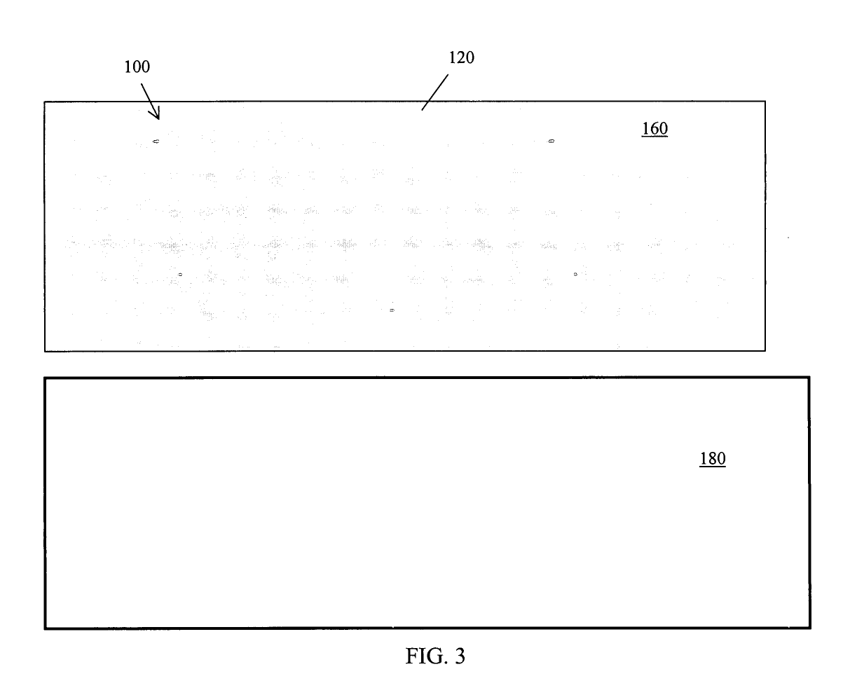

FIGS. 1-3 show an exemplary learning card 100 having a front side 110 and a back side 120. The front side includes a background 130, first information 140, and second information 150. The second information is related to the first information. The back side includes an adhesive 160 for adhering to any of a variety of surfaces. The adhesive can be removed from a surface and re-adhered to the same or a different surface. A release liner 180 is adapted to contact the adhesive 160 on the back side 120 of the learning card 100. The adhesive on the back side of the learning card is separated from the release liner prior to adhering the adhesive to any of a variety of surfaces. Optionally, the release liner 180 includes a tab 190. The tab eases separation of the release liner from the adhesive. Once the learning card 100 is separated from the release liner 180, the adhesive 160 on the back side of the learning card 100 may be adhered to any of a variety of surfaces. The learning card 100 is used to aid a person learning the relationship between the first information 140 and the second information 150.

Any of a variety of types of first information and second information may be presented on the learning card to aid a person learning the relationship between the first information and the second information. In one embodiment, the first information is a word and the second information is the definition of the word, for example, the word is “culpable” and the definition is “guilty.” The first information and the second information may be in the English language or any of a variety of languages.

Optionally, the first information and/or second information are words, definitions, or other information that a certain group of students studies. For example, the first information and the second information on the learning cards is information taught to a school grade level, a reading level, English as a Second Language (ESL) students, and standardized exam students. Suitable school grade levels include, for example, kindergarten through the final year of high school. Standardized exam students include, for example, Scholastic Aptitude Test (SAT) students, American College Test (ACT) students, Test of English as a Foreign Language (TOEFL) students, Law School Admissions Test (LSAT) students, Graduate Records Exam (GRE) students, and Graduate Management Admissions Test (GMAT) students. Alternatively, the first and/or second information on the learning card or learning cards relates to a specific topic. For example, the first information and/or second information are selected from words, definitions, and/or other information related to science, geography, history, or other specific topic.

In another embodiment, the first information is a mathematical term and the second information includes a symbol related to the mathematical term. The first information is, for example, the name of a mathematical symbol, formula, and/or theorem and the second information includes, for example, the corresponding symbol or symbols. In an exemplary learning card the first information is “Pythagorean theorem” and the second information is the formula “a²+b²=c²”. The student viewing the learning card learns the relationship between the first information and the second information, specifically, the symbols that relate to the mathematical term.

In another embodiment, the first information is geography information and the second information is related geography information. For example, the first information is the name of a country and the second information is the name of its capital. Alternatively, the first information is the name of a state (e.g., “Massachusetts”) and the second information is the name of the state capital (e.g., “Boston”). The student viewing the learning card learns the relationship between the first information and the second information, specifically, the capital of the state or the country. In another example, the first information is a geography word, symbol, shape or picture (e.g., the name of a country) and the second information is a geography word, symbol, shape or picture (e.g., the shape of the country as it appears on a map). The student viewing the learning card learns the shape of the specified country as it appears on a map.

In another embodiment, the first information is a question and the second information is an answer to the question. The first information and the second information may relate to any of a variety of topics and non-limiting examples include mathematics, science (e.g., chemistry, organic chemistry, biology, physics and earth science), geography, history, math, literature, and current events. The student viewing the learning card learns the relationship between the first information and the second information, specifically, that the second information is the answer to the question posed by the first information.

In still another embodiment, the first information is a word in a first language and the second information is the translation of the word in a language other than the first language. Any of a variety of languages are contemplated and non-limiting examples of languages include: French, English, German, Spanish, Latin, Russian, Italian, Greek, Japanese, Chinese, Korean, and Arabic. The student viewing the learning card learns the relationship between the first information and the second information, specifically, the second information provides the translation of the first information in a language other than the first language.

The above examples of second information related to first information are non-limiting. The learning cards of the invention may include any of a variety of first information and second information to be learned.

The first information and/or the second information are, for example, words, symbols, pictures, diagrams, shapes or a combination thereof. In one embodiment, the first information has a first typeface and the second information has a second typeface. The first typeface can be the same as or differ from the second typeface. The typeface may be, for example, a print style or a cursive style. In one embodiment, the first typeface is a print style and the second typeface is a cursive style, alternatively, both the first typeface and the second typeface are a cursive style. In one embodiment, the cursive style is similar in style to cursive handwriting. In another embodiment, the print style is similar in style to printed handwriting.

In one embodiment, the first typeface is a larger size than the second typeface, for example, the first typeface is at least about 400% larger in size than the second typeface. In another embodiment, the first typeface is at least about 20% larger in size than the second typeface. In still another embodiment, the first typeface is at least about 200% larger in size than the second typeface. In still another embodiment, the first typeface is at least about 850% larger in size than the second typeface. In one embodiment, the first typeface is at least about 700% larger in size than the second typeface. Alternatively, the second typeface is a larger size ranging from, for example, at least 20% larger, at least 200% larger, at least 400% larger, at least 700% larger, to at least 850% larger in size than the first typeface. In another embodiment, the first and second typeface are the same size.

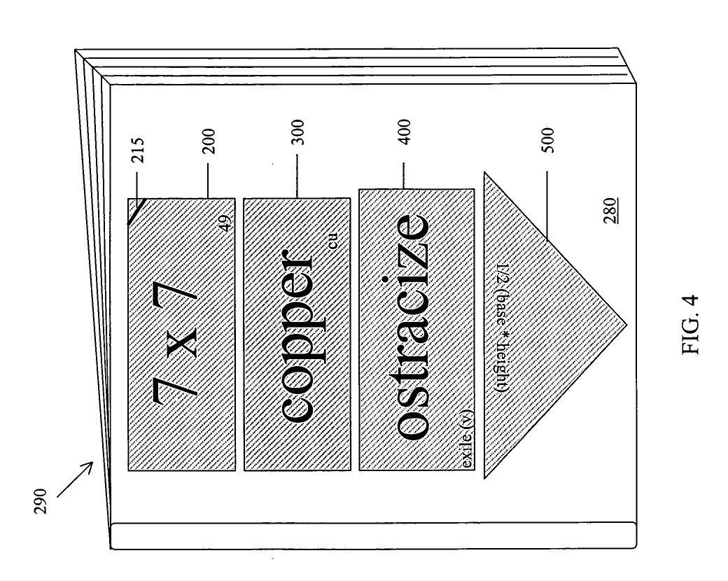

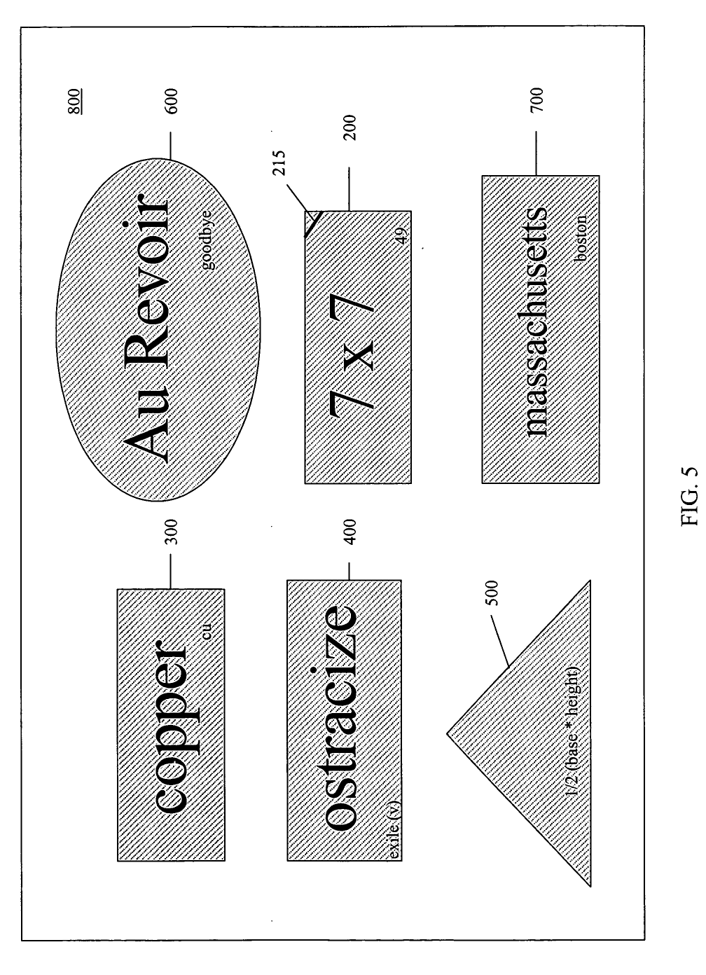

The learning card may have a shape having at least three sides, for example, a triangle, rectangle, hexagon or pentagon. Referring now learning card 500 in FIG. 4, in one embodiment, the first information is the shape of the learning card and the learning card is the shape of a triangle, and the second information is the formula for the area of a triangle, ½ (base * height). Alternatively, the learning card shape has at least a portion of a curve, and is, for example, circular or oval, see, e.g., learning card 600 in FIG. 5.

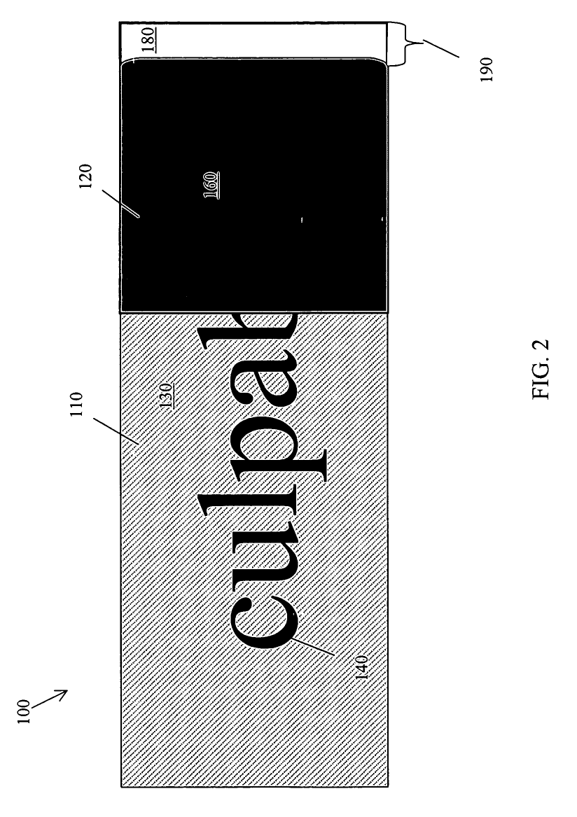

Referring still to FIGS. 1 and 2, the background 130 of the front side 110 may include any of a variety of colors and the first information 140 and second information 150 may include any of a variety of colors. In one embodiment, the first information, second information and the background respectively have a first, a second, and a third shade of the same color. In another embodiment, the first information has a first color, the second information has a second color and the background has a third color. Optionally, the symbols or letters of the first information and/or the second information is outlined in one color and is filled in with a different color. Colors may be selected according to the specific learning card.

Optionally, one or more context indicators are provided in the learning card. Color, learning card shape, an indication on the learning card regarding: the language of origin, part of speech (e.g., noun, adjective etc.), the tense of the word, or other context that aids in learning the information may, for example, together or in combination provide one or more context indicator to a learning card. Context indicators may be employed to indicate the area of study for example, that a definition of a word is sought, the specific topic, e.g., whether the question is a science or history question. Context indicators may be employed in any of a variety of ways. Non-limiting examples include shaping vocabulary cards related to scientific terms in a hexagonal shape. Referring now to FIG. 1, the learning card 100 includes a context indicator 155. The context indicator 155 is the letter “a” for adjective, indicating the part of speech of the first information 140 and the second information 150. In one embodiment, the background color of a card indicates the part of speech of the first information, e.g., vocabulary learning cards featuring a first information that is a verb have a red background color. Use of color (e.g., background, first information and/or second information color) as a context indicator facilitates differentiation between multiple learning cards and memorization and long term retention of information to be learned by the student.

The learning card may be composed of materials known in the art of making papers, labels and stickers. The material may be, for example, paper, foil, film, or a combination thereof. Suitable film material include, for example, polymer film material. The material or the learning card may include a finish, for example, glossy, satin, metallic, matte or combination thereof. Materials employed to make the labels includes paper that is laminated together, e.g., two or more types of paper may be laminated together to form the materials employed to make the learning cards. Suitable papers that may be employed include, but are not limited to, an 4.0-ml paper stock having a high gloss finish available from Artex Label & Graphics, Inc. (Zeeland, Mich.). Other suitable paper, film, or foil materials may be known to the skilled person or may be available from other manufacturers and suppliers known to the skilled person.

The learning card may include printing on all or on portions of its front side and/or its back side. As used herein, printing may include any colored ink, including white ink and black ink, printed on the label. Suitable inks that may be employed include liquid based inks, e.g., solvent-based or water-based inks, such as, for example, water based inks having a neutral pH available from Artex Label & Graphics, Inc. (Zeeland, Mich.). The first information, second information and the background may be printed with suitable materials known in the printmaking arts.

In one embodiment, glow in the dark ink or other glow in the dark materials are employed to make the learning card. The glow in the dark portions of the learning card facilitate differentiation between learning cards and memorization and long term retention of the first information and/or the second information on the learning card.

A learning card may be printed using printing techniques known in the art for printing inks on paper, film, foil and other substrates. Printing techniques that may be employed include, but are not limited to, offset-lithographic (wet, waterless and dry), flexographic, rotogravure (direct or offset), intaglio, ink jet, electrophotographic (laser jet and photocopy), and letterpress printing. Personal printers, e.g., ink jet and laser jet printers, also can be used to print information in accordance with the present invention. Suitable printing techniques include employing a MARKANDY flexographic press available from Mark Andy, Inc. (Chesterfield, Mo.). The first information, second information and the background may be printed by other printing techniques known to the skilled person.

Adhesive is disposed on the back side of the learning card. The adhesive is adapted to adhere to any of a variety of surfaces and to be removable and re-adhereable to the same or a different one of the surfaces. Any of a variety of adhesives that are adhereable, removable, and re-adhereable may be used in accordance with the learning card. In one embodiment, the adhesive is a water based adhesive. Suitable water based adhesives include T1055 Temporary Adhesive™ available from NASTAR (Middleton, Wis.). In another embodiment, the adhesive is polymer based. Suitable adhesives include Silicon, Acrylic and/or Emulsion Acrylic based adhesives. The Emulsion Acrylic adhesive #UR1 available from FASSON Roll North America (Painseville, Ohio) may be employed in accordance with the invention. Other suitable adhereable, removable and re-adhereable adhesives known to the skilled person or available in the adhesive arts may be employed.

Adhesive may disposed on all or on a portion or portions of the back side of the learning card. Referring now to FIG. 4, a corner 215 of the back side of learning card 200 is free from adhesive and adhesive is disposed on the remainder of the back side of learning card 200. With the corner 215 free from adhesive, the learning card 200 may easily be removed from the release liner 280.

Referring now to FIGS. 1-4, the adhesive on the back side of the learning card contacts a release liner, 180 and 280. The release liner is adapted to contact the adhesive. Generally, adhesive on the back side of a learning card contacts a release liner when the learning card is being stored and is not in use. The release liner holds and stores learning cards and protects the adhesive on the back side of the learning card from contamination by substances, for example, dust, that might reduce the adhesive and re-adhesive properties of the learning card. Further, the release liner enables the learning card to be manufactured using one or more printing techniques and cutting techniques without the learning card becoming adhered to the manufacturing equipment. The release liner may be selected to suit the paper stock, for example, a FASSON 50# release liner available from FASSON Roll North America (Painseville, Ohio) may be employed to ensure that the learning card lays flat. Suitable release liners are made from materials including, but not limited to, FASSON 40# release liner available from FASSON Roll North America (Painseville, Ohio). Other release liners known to the skilled person that are suitable for use with a selected adhereable, removable, and re-adhereable adhesive may be employed.

Referring now to FIGS. 1-3, the release liner 180 includes a tab 190 to ease separation of the release liner from the adhesive. For example, the user grasps the tab 190 portion of the release liner 180 and pulls the release liner 180 away from the adhesive on the back side of the learning card. In one embodiment, a single release liner is adapted to hold one or more learning cards. Alternatively, portions of a single sheet of material include both release liner material and other materials, for example, paper, cardboard, or film. Referring now to FIG. 4, multiple learning cards 200, 300, 400, and 500 are adhered to the release liner 280. In one embodiment, a portion of the back side of the learning card (e.g., learning card 200) is free from adhesive (e.g., the corner 215 is free from adhesive) to ease removal of the learning card from the release liner.

One or more release liners 280 are presented in a compilation 290. Suitable compilations include a book having multiple release liners attached together by a binding. Alternatively, a binder, for example, a single or multi ring binder includes a ring or rings adapted to fit through one or more apertures disposed in one or more release liners. Optionally, the compilation is a folder adapted to receive one or more release liners.

According to exemplary methods of making the learning cards of the invention. An 4.0-ml paper stock having a high gloss finish on the front side available from Artex Label & Graphics, Inc. (Zeeland, Mich.) is obtained. A water based adhesive T1055 Temporary Adhesive™ available from NASTAR (Middleton, Wis.) is disposed on the back side of the paper stock and the adhesive is contacted with a FASSON 40# release liner available from FASSON Roll North America (Painseville, Ohio), forming a substrate. In one embodiment, the substrate is printed with a water based pH neutral ink available from Artex Label & Graphics, Inc. (Zeeland, Mich.) using a MARKANDY flexographic printing press available from Mark Andy, Inc. (Chesterfield, Mo.). After printing, the substrate is cut with a die cutting tool. The shape of the die cutting tool is selected according to the desired learning card shape. In an alternative embodiment, the substrate is first cut into the desired shape using the die cutting tool and thereafter the learning cards are printed with, for example, a laser printer.

In one embodiment, a compilation includes eighteen FASSON 50# lay flat release liner sheets, available from FASSON Roll North America (Painseville, Ohio), bound together by a perfect bound binding. According to a method of making the bound compilation, a 4.0-ml paper stock having a high gloss finish available from Artex Label & Graphics, Inc. (Zeeland, Mich.) is provided and the back side of the paper stock is disposed with T1055 Temporary Adhesive™ available from NASTAR (Middleton, Wis.). The adhesive is contacted with the FASSON 50# lay flat release liner forming a substrate.

The substrate is cut into sheets measuring about 8.4 inches by about 10.9 inches. Thereafter, die(s) selected according to the desired learning card shape(s) are employed to cut the learning card shapes from the substrate. Optionally, substrate waste is removed from the release liner leaving only the adhesive on the back side of the learning cards adhered to the release liner. Thereafter, the learning cards are printed with a water based pH neutral ink available from Artex Label & Graphics, Inc. (Zeeland, Mich.) according to a suitable printing method described above. In alternate embodiments, the steps including cutting the substrate, die cutting the learning card shapes, and printing the learning cards are accomplished in a different order, for example, the substrate is printed, the learning cards are die cut and then the release liner to which the learning cards are adhered is cut into sheets sized according to the desired compilation size.

Thereafter 18 sheets of release liner to which the learning cards are adhered are collated and bound using a perfect bound binding. Optionally, one or more cover having a 10 pt cover stock is bound together with the 18 sheets of release liner.

According an exemplary system for instructing, the system includes a plurality of learning cards in which the first information of at least one of the plurality of learning cards is different than the first information of at least a different one of the plurality of learning cards. A different first information is included in at least two of the learning cards of the plurality. The plurality of learning cards includes, for example, one or more words, mathematical terms, geography related information, and questions.

In one embodiment, the second information of at least one of the plurality of learning cards is different than the second information of at least a different one of the plurality of learning cards. According to this embodiment, a different first information is included in at least two of the learning cards of the plurality and a different second information is included in at least two of the learning cards of the plurality. For example, two different vocabulary words having two different definitions are provided according to this system of the invention.

In one embodiment, the plurality of learning cards are packaged together. The package may be, for example, a paper, plastic, or wooden box or a plastic package made from, for example, recycled polyethylene.

In another embodiment, in at least one learning card of the plurality the first information is a word written in a first color, the second information is a word written in a second color, and the background is a third color. For example, a first learning card of the plurality has the first information, the word “precept,” in the first color, white, the second information, the word “rule,” in the second color, black, and the background is the third color, red. Optionally, the first information is written in a print style typeface and the second information is written in a cursive style typeface. A second learning card of the plurality has the first information, the word “ostracize” in the first color, white, and the second information, the word “exile” in the second color, black, and the background is in the third color, green. The relationship between the first information and the second information of this plurality of learning cards is that the second information is the definition of the first information.

Optionally, one or more of the colors provides another layer of context. For example, the context indicator is that the color of the first information indicates that a definition of the first information is sought. Alternatively, the learning card background color indicates the part of speech of the term, for example, in the first card the background color red indicates that the first information “precept” is a noun and in the second card the background color green indicates that the first information “ostracize” is a verb. The use of color in the background as the context indicator facilitates differentiation of the words “precept” and “ostracize” by the student and aids in memorization of the information to be learned by the student.

An exemplary method of instructing a student includes, providing a learning card, instructing the student to removably adhere the back side of the learning card to any of a variety of surfaces, and instructing the student to view the learning card. One embodiment of the method of instruction includes providing a plurality of learning cards. Another embodiment includes providing a plurality of learning cards and instructing the student to view a plurality of learning cards. FIG. 5 shows a plurality of learning cards 200, 300, 400, 500, 600, and 700 removably adhered to a surface 800. The surface is, for example, a wall of a study area. Suitable study areas include, for example, a bedroom, office, or library study carrel. The learning cards are positioned, for example, adjacent to one another on the same surface. Unlike traditional flash cards, the student cannot avoid studying, because the learning cards are on the surfaces in and around the study area. The student is unable to get away from information included on the learning cards in the study area. The student only has to view the front side of the learning card to see the first information and the second information to be learned.

The difference in the size, print style and color of the first information typeface and the second information typeface may be selected to force the student to learn the information on the learning card and to avoid, even unintentional, student cheating. Learning card(s) are adhered a surface in the study area. In one embodiment, the first information and the second information are both legible when viewed up close. However, the student is only able to read the first information and is unable to read the second information when standing at a distance, for example, three or more feet from the learning card. The student standing at a distance from the learning card where the first information is readable and the second information is too small to read is able to test his knowledge of how the second information relates to the first information. Thereafter, the student moves closer to the learning card to be able to read the second information and confirm whether he has learned the relationship between the first information and the second information.

In one embodiment, the first information first typeface is a larger font, for example 400% larger, than the second information second typeface. Accordingly, a student who is self testing can avoid reading the second information, for example, an answer posed by a first information question according to the distance he stands from the learning card. In order to make the second information even more difficult to read from a distance, the second typeface color may be selected to blend into the background color, or be a dark color, for example black, brown or blue. Further, the second information may have a cursive typeface style, which is more difficult to read from a distance. The size, style, and color of the first and/or second information typeface may be altered to enable students to view the first and/or second information from a desired distance.

Learning cards may be adhered to any of a variety of surfaces in accordance with a student study method. The student views the surface where learning cards containing the information to be learned are adhered. In one embodiment, the student is faced with multiple learning cards in the same learning area, e.g., on a single surface. In another embodiment, a student adheres multiple learning cards to a single surface and the student simultaneously views multiple learning cards. The learning cards of the invention improve over prior art information memorization techniques, for example, flash cards, because the student is not limited to studying one item at a time. Rather, the student is surrounded by the information to be learned and is able to simultaneously view multiple learning cards. Optionally, the student can focus his attention on a select group of terms that he struggles with learning. For example, the terms that need to be learned can be placed where the students' attention is most likely to turn to, e.g., on the wall across from where the student is seated at his desk.

In one embodiment, the student views multiple learning cards on multiple surfaces. For example, one surface may be dedicated to learning cards containing information related to vocabulary studies and another surface has learning cards related to mathematical terms. Optionally, the student simultaneously views multiple cards on multiple surfaces.

The student viewing multiple learning cards at a single point in time studies the information on multiple learning cards at the same time. The multiple learning cards may relate to different subjects, different topics or be related to a single subject, for example a student may simultaneously view multiple SAT vocabulary learning cards. A student surrounded by multiple learning cards in his study area is immersed in the learning environment created by the learning cards.

In one embodiment, a student is surrounded in his study area by a certain plurality of learning cards that he views for the period of his examination preparation. In another embodiment, a student constantly changes the learning cards adhered to the surfaces of his study area, the changes are made, for example, as he learns information on certain learning cards, according to a study schedule, or on a regular basis.

Another exemplary method of instructing includes providing a learning card, providing instructions to removably adhere the back side of the learning card to any of a variety of surfaces, and providing instructions to view the learning card. One embodiment includes providing a plurality of learning cards and, alternatively, providing instructions to view a plurality of learning cards. The plurality of learning cards may, for example, be adhered to a single surface or to multiple surfaces. Such instructions may be provided with, for example, a compilation, pack or a kit including learning card(s).

Another exemplary method of student instruction includes obtaining a learning card, removably adhering the back side of the learning card to any of a variety of surfaces, and viewing the learning card. One embodiment includes obtaining a plurality of learning cards and, alternatively, viewing a plurality of learning cards. In one embodiment, a student obtains a plurality of learning cards and removably adheres the back side of the learning cards to the surfaces of his study area. The student views the learning cards that surround his study area.

In one embodiment, a plurality of learning cards is provided and two or more of the learning cards include related information. The related learning cards of the plurality may be viewed individually or as part of a combination. For example, multiple related learning cards together convey related information about a common system, for example, a scientific system. The related learning cards may be provided on one or more release liners according to an appropriate order of the system. For example, multiple related learning cards together present information about the Krebs cycle. Optionally, multiple related learning cards are presented in a specific order on the release liner and the student may replicate the specific order on a surface of his study area. In one embodiment, the student adheres all of the cards to a surface of his study area and as he learns portions of the system he removes the learning cards that he has learned. In another embodiment, the related learning cards have shapes that are adapted to fit together, much like pieces of a puzzle, to present an image or a pattern.

In one embodiment, a number of learning cards include information about plants and animals indigenous to a single common environment. The learning cards are used together to teach about the plants and animals indigenous to the common environment or country. For example, in a first learning card the first information is a photograph of a panda bear and the second information is the words “panda bear” and in a second related learning card the first information is a photograph of a bamboo plant and the second information is the word “bamboo.” The first and the second learning cards include information about the country China and can be used together to learn to identify the “panda bear” as indigenous to China or individually to learn to identify the “panda bear”. Optionally, the learning cards may include one or more context indicator that indicates that each card is related to China, for example, the shape of the card, the background color, or another indicator, such as, for example, the word “China” may be written on the front side of the card. In one embodiment, the learning cards related to China are adapted to fit together into the shape of the country China as it appears on a map.

Another exemplary method of the invention includes employing audio materials that are played in the study area. In one embodiment, the audio materials direct the student's attention to specific learning cards that are in the study area.

The invention may be embodied in other specific forms without departing from the spirit or essential characteristics thereof. The foregoing embodiments are illustrative of, rather than limiting on, the invention.

1. A learning card, comprising:
a front side comprising a background, first information, and second information, the second information related to the first information; and
a back side comprising an adhesive adapted to adhere to any of a variety of surfaces and to be removable and re-adhereable to the same or a different one of the surfaces, the learning card to aid a person learning the relationship between the first information and the second information.

2. The learning card of claim 1, wherein the first information comprises a mathematical term and the second information comprises a symbol related to the mathematical term.

3. The learning card of claim 1, wherein the first information comprises geography information and the second information comprises related geography information.

4. The learning card of claim 1, wherein the first information comprises a question and the second information comprises an answer to the question.

5. The learning card of claim 1, wherein the first information comprises a word and the second information comprises a definition of the word.

6. The learning card of claim 5, wherein the word is a scientific term.

7. The learning card of claim 1, wherein the first information comprises a word in a first language and the second information comprises the translation of the word in a language other than the first language.

8. The learning card of claim 7, wherein the first information is in French and the second information is in English.

9. The learning card of claim 7, wherein the first information is in Spanish and the second information is in English.

10. The learning card of claim 1, wherein the first information has a first color, the second information has a second color, and the background has a third color.

11. The learning card of claim 1, wherein the first information comprises a first typeface and the second information comprises a second typeface.

12. The learning card of claim 11, wherein the first typeface is a larger size than the second typeface.

13. The learning card of claim 11, wherein the first typeface is at least about 400% larger in size than the second typeface.

14. The learning card of claim 11, wherein the second typeface is a larger size than the first typeface.

15. The learning card of claim 11, wherein the first typeface comprises a print style and the second typeface comprises a cursive style.

16. The learning card of claim 1, wherein the adhesive is a water based adhesive.

17. The learning card of claim 1, further comprising a release layer adapted to contact the adhesive.

18. The learning card of claim 17, wherein the release layer further comprises a tab.

19. The learning card of claim 1, wherein the learning card comprises a shape having at least three sides.

20. The learning card of claim 1, wherein the learning card comprises a shape having at least a portion of a curve.

21. A system for instructing, comprising:
a plurality of learning cards, each of the plurality of learning cards comprising:
a front side comprising a background, first information, and second information, the second information related to the first information;
a back side comprising an adhesive adapted to adhere to any of a variety of surfaces and to be removable and re-adhereable to the same or a different one of the surfaces; and
the first information of at least one of the plurality of learning cards is different than the first information of at least a different one of the plurality of learning cards.

22. The system of claim 21, wherein the second information of at least one of the plurality of learning cards is different than the second information of at least a different one of the plurality of learning cards.

23. The system of claim 21, wherein at least one of the plurality of learning cards comprises the first information comprising a first color, the second information comprising a second color, and the background comprising a third color.

24. The system of claim 21, wherein the first information comprises a first typeface and the second information comprises a second typeface.

25. The system of claim 24, wherein the first typeface is a larger size than the second typeface.

26. The system of claim 24, wherein the first typeface is at least about 400% larger in size than the second typeface.

27. The system of claim 24, wherein the second typeface is a larger size than the first typeface.

28. A method of instructing a student, comprising:
providing a learning card comprising:
a front side comprising a background, first information, and second information, the second information related to the first information; and
a back side comprising an adhesive;
instructing the student to removably adhere the back side of the learning card to any of a variety of surfaces; and
instructing the student to view the learning card.

29. The method of claim 28, wherein the first information has a first color, the second information has a second color, and the background has a third color.

30. The method of claim 28, wherein the first information comprises a first typeface and the second information comprises a second typeface.

31. The method of claim 30, wherein the first typeface is a larger size than the second typeface.

32. The method of claim 30, wherein the first typeface is at least about 400% larger in size than the second typeface.

33. The method of claim 30, wherein the second typeface is a larger size than the first typeface.

34. The method of claim 30, wherein the first typeface comprises a print style and the second typeface comprises a cursive style.

35. The method of claim 28, further comprising:
providing a plurality of learning cards.

36. The method of claim 28, further comprising:
providing a plurality of learning cards; and
instructing the student to view a plurality of learning cards.

37. A method of instructing, comprising:
providing a learning card comprising:
a front side comprising a background, first information, and second information, the second information related to the first information; and
a back side comprising an adhesive;
providing instructions to removably adhere the back side of the learning card to any of a variety of surfaces; and
providing instructions to view the learning card.

38. The method of claim 37, wherein the first information has a first color, the second information has a second color, and the background has a third color.

39. The method of claim 37, wherein the first information comprises a first typeface and the second information comprises a second typeface.

40. The method of claim 39, wherein the first typeface is a larger size than the second typeface.

41. The method of claim 39, wherein the first typeface is at least about 400% larger in size than the second typeface.

42. The method of claim 39, wherein the second typeface is a larger size than the first typeface.

43. The method of claim 39, wherein the first typeface comprises a print style and the second typeface comprises a cursive style.

44. The method of claim 37, further comprising:
providing a plurality of the learning cards.

45. The method of claim 37, further comprising:
providing a plurality of learning cards; and
providing instructions to view a plurality of learning cards.

46. A method of student instruction, comprising:
obtaining a learning card comprising:
a front side comprising a background, first information, and second information, the second information related to the first information; and
a back side comprising an adhesive;
removably adhering the back side of the learning card to any of a variety of surfaces; and
viewing the learning card.

47. The method of claim 46, wherein the first information has a first color, the second information has a second color, and the background has a third color.

48. The method of claim 46, wherein the first information comprises a first typeface and the second information comprises a second typeface.

49. The method of claim 48, wherein the first typeface is a larger size than the second typeface.

50. The method of claim 48, wherein the first typeface is at least about 400% larger in size than the second typeface.

51. The method of claim 48, wherein the second typeface is a larger size than the first typeface.

52. The method of claim 48, wherein the first typeface comprises a print style and the second typeface comprises a cursive style.

53. The method of claim 46, further comprising:
obtaining a plurality of learning cards.

54. The method of claim 46, further comprising:
obtaining a plurality of learning cards; and
viewing a plurality of learning cards.
